(19) United States
(12) Patent Application Publication
(10) Pub. No.: US 2024/0430724 A1
(43) Pub. Date: Dec. 26, 2024

(54) LAYER 1 REFERENCE SIGNAL RECEIVED POWER REPORTING

(71) Applicant: LENOVO (BEIJING) LIMITED, Beijing (CN)

(72) Inventors: Chenxi Zhu, Fairfax, VA (US); Bingchao Liu, Beijing (CN); Yi Zhang, Beijing (CN)

(21) Appl. No.: 18/683,454

(22) PCT Filed: Aug. 13, 2021
(86) PCT No.: PCT/CN2021/112441

§ 371 Date: Feb. 13, 2024

(51) Int. Cl. H04W 24/10; H04B 17/318

(52) U.S. Cl. CPC H04W 24/10; H04B 17/328

(57) ABSTRACT

Apparatuses, methods, and systems are disclosed for layer 1 reference signal received power reporting. One method includes receiving a radio resource control configuration message including a channel state information report configuration. The channel state information report configuration includes a first list of reference signals sent from a serving cell, a second list of reference signals sent from at least one non-serving cell, or a combination thereof. The method includes determining that a largest layer 1 reference signal received power of reference signals from the first list of reference signals sent from the serving cell is below a first threshold.

### FIELD

The subject matter disclosed herein relates generally to wireless communications and more particularly relates to layer 1 reference signal received power reporting.

### BACKGROUND

In certain wireless communications networks, power consumption of a user equipment may be excessive as a result of measuring too many reference signals. Thus, the user equipment may be inefficient.

### BRIEF SUMMARY

Methods for layer 1 reference signal received power reporting are disclosed. Apparatuses and systems also perform the functions of the methods. In one embodiment, the method includes receiving a radio resource control configuration message including a channel state information report configuration. The channel state information report configuration includes a first list of reference signals sent from a serving cell, a second list of reference signals sent from at least one non-serving cell, or a combination thereof. In various embodiments, the method includes determining that a largest layer 1 reference signal received power of reference signals from the first list of reference signals sent from the serving cell is below a first threshold.

An apparatus for layer 1 reference signal received power reporting, in one embodiment, includes a user equipment. In some embodiments, the apparatus includes a receiver that: receives a radio resource control configuration message including a channel state information report configuration. The channel state information report configuration includes a first list of reference signals sent from a serving cell, a second list of reference signals sent from at least one non-serving cell, or a combination thereof. In various embodiments, the apparatus includes a processor that determines that a largest layer 1 reference signal received power of reference signals from the first list of reference signals sent from the serving cell being below a first threshold.

In various embodiments, a method for layer 1 reference signal received power reporting includes transmitting, to a user equipment, a radio resource control configuration message includes a channel state information report configuration. The channel state information report configuration comprises a first list of reference signals sent from a serving cell, a second list of reference signals sent from at least one non-serving cell, or a combination thereof. In some embodiments, the method includes receiving a channel state information report including layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof.

In some embodiments, an apparatus for layer 1 reference signal received power reporting includes a network device. In such embodiments, the apparatus includes a transmitter that: transmits, to a user equipment, a radio resource control configuration message including a channel state information report configuration. The channel state information report configuration includes a first list of reference signals sent from a serving cell, a second list of reference signals sent from at least one non-serving cell, or a combination thereof. Moreover, in such embodiments, the apparatus includes a receiver that receives a channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof . . .

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for layer 1 reference signal received power reporting;

FIG. 2 is a schematic block diagram illustrating one embodiment of an apparatus that may be used for layer 1 reference signal received power reporting;

FIG. 3 is a schematic block diagram illustrating another embodiment of an apparatus that may be used for layer 1 reference signal received power reporting;

FIG. 4 is a schematic block diagram illustrating one embodiment of a UE handover;

FIG. 5 is a schematic flow chart diagram illustrating one embodiment of a method for layer 1 reference signal received power reporting; and

FIG. 6 is a schematic flow chart diagram illustrating another embodiment of a method for layer 1 reference signal received power reporting.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

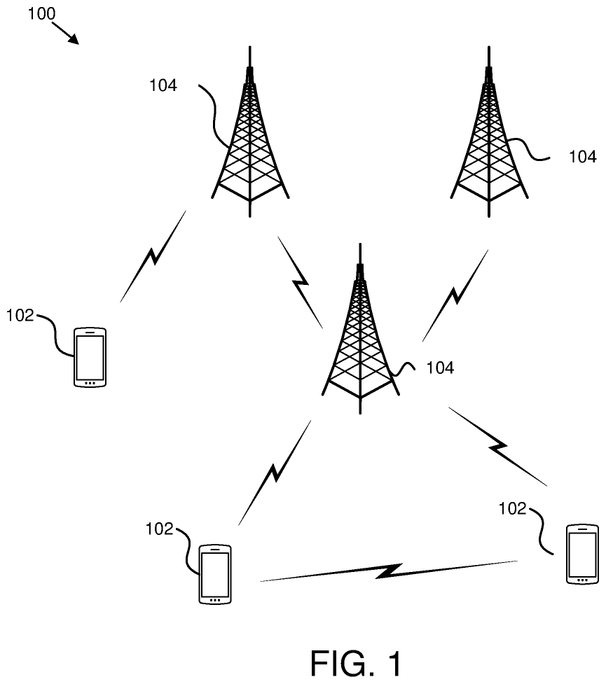

FIG. 1 depicts an embodiment of a wireless communication system 100 for layer 1 reference signal received power reporting. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”), a Home Node-B, a RAN, a relay node, a device, a network device, an integrated and access backhaul (“IAB”) node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

In various embodiments, a remote unit 102 may receive a radio resource control configuration message including a channel state information report configuration. The channel state information report configuration includes a first list of reference signals sent from a serving cell, a second list of reference signals sent from at least one non-serving cell, or a combination thereof. In various embodiments, the remote unit 102 may determine that a largest layer 1 reference signal received power of reference signals from the first list of reference signals sent from the serving cell is below a first threshold. Accordingly, a remote unit 102 may be used for layer 1 reference signal received power reporting.

In some embodiments, a network unit 104 may transmit, to a user equipment, a radio resource control configuration message includes a channel state information report configuration. The channel state information report configuration comprises a first list of reference signals sent from a serving cell, a second list of reference signals sent from at least one non-serving cell, or a combination thereof. In some embodiments, the network unit 104 may receive a channel state information report including layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof. Accordingly, a network unit 104 may be used for layer 1 reference signal received power reporting.

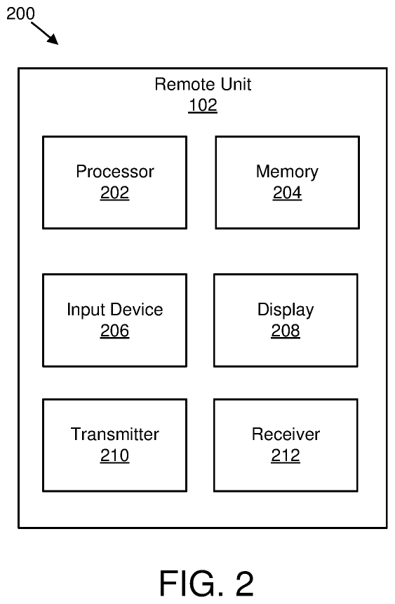

FIG. 2 depicts one embodiment of an apparatus 200 that may be used for layer 1 reference signal received power reporting. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In various embodiments, the receiver 212: receives a radio resource control configuration message including a channel state information report configuration. The channel state information report configuration includes a first list of reference signals sent from a serving cell, a second list of reference signals sent from at least one non-serving cell, or a combination thereof. In some embodiments, the processor 202 determines that a largest layer 1 reference signal received power of reference signals from the first list of reference signals sent from the serving cell being below a first threshold.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

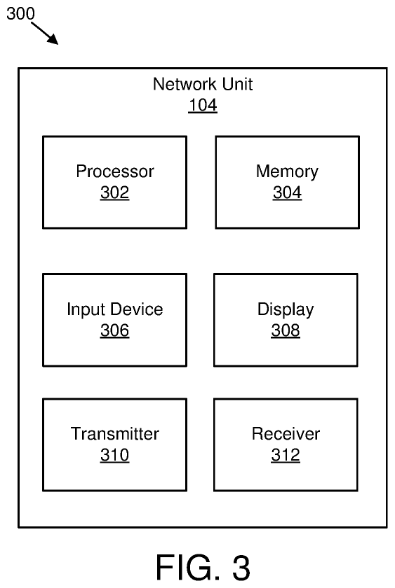

FIG. 3 depicts another embodiment of an apparatus 300 that may be used for layer 1 reference signal received power reporting. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310: transmits, to a user equipment, a radio resource control configuration message including a channel state information report configuration, wherein the channel state information report configuration includes a first list of reference signals sent from a serving cell, a second list of reference signals sent from at least one non-serving cell, or a combination thereof. The channel state information report configuration includes a first list of reference signals sent from a serving cell, a second list of reference signals sent from at least one non-serving cell, or a combination thereof. Moreover, in some embodiments, the receiver 312 receives a channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, to support inter-cell layer 1 (“L1”) and/or layer 2 (“L2”) centric inter-cell mobility, reference signals from non-serving cells may be configured for a user equipment (“UE”) for measurement and reporting. In some embodiments, a synchronization signal block (“SSB”) from non-serving cells may be used for L1 reference signal received power (“RSRP”) (“L1-RSRP”) measurement and reporting. In various embodiments, a channel state information (“CSI”) reference signal (“RS”) (“CSI-RS”) from non-serving cells may be used for L1-RSRP measurement and reporting. In certain embodiments, SSBs and/or CSI-RSs from non-serving cells may be configured together with RSs from a serving cell in the same CSI-ReportConfig and may be reported together in a same CSI feedback. In some embodiments, for L1-RSRP measurement and reporting, only SSBs and non-zero power (“NZP”) CSI-RSs (“NZP-CSI-RSs”) may be configured for channel measurement, and no resource may be needed for interference measurement. In such embodiments, a reported quantity may be ssb-Index-RSRP or cri-RSRP. Moreover, in such embodiments, no CSI-RS and SSB may be configured in a same CSI-ReportConfig. In various embodiments, in a CSI-ReportConfig, a UE may be configured with 1 CSI-SSB-ResourceSet with up to 64 SSB resources. In such embodiments, if SSBs from non-serving cells are included in the same CSI-SSB-ResourceSet, they may include more than one non-serving cell located in different directions with respect to the serving cell. In certain embodiments, a UE may be configured with and report at least one SSB from both a serving cell and a non-serving cell in a same CSI-ReportConfig (e.g., configured by radio resource control (“RRC”)), and report L1-RSRP from both the serving cell and non-serving cell. In such embodiments, the report may include up to K RSs from non-serving cell in a single report together with a RS from the serving cell. In some embodiments, after channel measurement resources (e.g., SSB or CSI-RS) are configured by RRC, a UE may conduct L1-RSRP measurements on all of them, and may report largest RSRP values and associated indices (e.g., SSB-Index or CSI-RS resource indicator (“CRI”)) in CSI feedback. In such embodiments, to change a set of RSs for the UE to measure may be made by sending the UE another RRC message (e.g., a new CSI-ReportConfig).

In various embodiments, it may be demanding for a UE to always measure many RS signals. In such embodiments, to reduce processing overhead and power consumption, the UE may measure some RSs (e.g., especially those from a non-serving cell) only when necessary.

In certain embodiments, RSs that a UE needs to measure may be controlled with a medium access control (“MAC”) control element (“CE”) (“MAC-CE”) message. In such embodiments, a subset of RSs may be activated at any time, and the UE may only need to measure active RSs and report a L1-RSRP from the subset.

In some embodiments, UE power consumption may be reduced by limiting a set of RSs the UE needs to measure (e.g., using SSBs for L1-RSRP measurement, using CSI-RS from non-serving cells for L1-RSRP measurement). In various embodiments, there may be an event-triggered MAC-CE report of L1-RSRP from a non-serving cell.

In various embodiments, a UE is configured with a CSI-ReportConfig (e.g., which includes: RS resources for channel measurement, RS resources for interference measurement, a report quantity, and uplink (“UL”) physical uplink control channel (“PUCCH”) resources for transmitting CSI feedback). In certain embodiments, a set of RSs for measurement and reporting may be changed through RRC reconfiguration, and a UE may be required to conduct measurement on all configured RSs (e.g., SSB or CSI-RS) and report the CSI from the measurement results. In some embodiments, for L1-RSRP measurement using SSB (or CSI-RS), only channel measurement resources are configured, and no resources for interference measurement may be needed.

In certain embodiments, a set of SSBs from both a serving cell and some neighboring non-serving cells may be configured by RRC in a CSI-ReportConfig. In some embodiments, up to 64 SSBs from a serving cell may be configured as a csi-SSB-ResourceSet, and this resource set may be configured for channel measurement with a CSI report quantity set to ssb-index-RSRP. To accommodate additional SSBs sent from non-serving cells, more SSB resources may need to be configured in a CSI-ReportConfig either in a second csi-SSB-ResourceSet or by increasing the maximum number of SSBs in a csi-SSB-ResourceSet from 64 to 128. Such an increase from 64 to 128 may increase UE processing and power consumption. Although a number of SSBs that are activated using a MAC-CE may be less than the maximum, this still may be challenging for the UE. In such embodiments, a gNB cannot deactivate all SSBs from non-serving cells for the UE to measure, because this may forfeit introducing measurement from non-serving cells to facilitate L1 and/or L2 handover. A subset of SSBs from non-serving cells may need to be measured by the UE.

In various embodiments, to reduce UE processing requirements, a set of SSBs required for measurement may be reduced if the UE uses a largest L1-RSRP of the SSBs from a serving cell as a precondition to measure SSBs from a non-serving cell. As may be appreciated, one purpose of reporting L1-RSRP of SSBs from the non-serving cell is to prepare the UE for a handover at L1 and/or L2 to a neighbor cell. This may take place if the UE roams into the boundary area of between two cells or into the coverage area of the neighbor cell. The channel quality from its current serving cell is usually not good in these areas. Thus, the UE may measure the L1-RSRP of the SSBs from its serving cell and use these measurement results to judge whether to start measuring and reporting the SSBs from its neighbor cells. In certain embodiments, a UE may take a largest L1-RSRP from all the SSBs of a serving cell (e.g., configured in a CSI-ReportConfig), Rₘₐₓ^{serving cell}, and compare with a threshold Rₜₕᵣₑₛₕ^{serving cell}, The UE may measure SSBs from a non-serving cell configured and activated (e.g., in the CSI-ReportConfig) only if:

Rₘₐₓ^{serving cell}<Rₜₕᵣₑₛₕ^{serving cell}

In some embodiments, a time at which the largest L1-RSRP from all SSBs of a serving cell is less than a threshold value is the time the UE has moved away from a center of the serving cell and the measurement of SSBs from neighbor cells become useful to a gNB to make a L1 and/or L2 handover preparation and decision. The point at which the largest L1-RSRP from all SSBs of the serving cell becomes less than the threshold value may be considered a triggering event as it triggers measurement by the UE on SSBs from other cells (e.g., neighbor cells, non-serving cells). It should be noted that the set of SSBs from neighbor cells may be configured and activated before the triggering event, and the UE starts measuring the SSBs from a non-serving cell without explicit signaling from the gNB. Thus, the measurements of the non-serving cell are autonomous and free of network supervision. In various embodiments, a threshold value (e.g., Rₘₐₓ^{serving cell}) may be configured by a gNB and transmitted to the UE through RRC signaling or may be predefined (e.g., defined in a specification). In one example, the threshold value is −118 dBm (e.g., Rₘₐₓ^{serving cell}=−118 dBm).

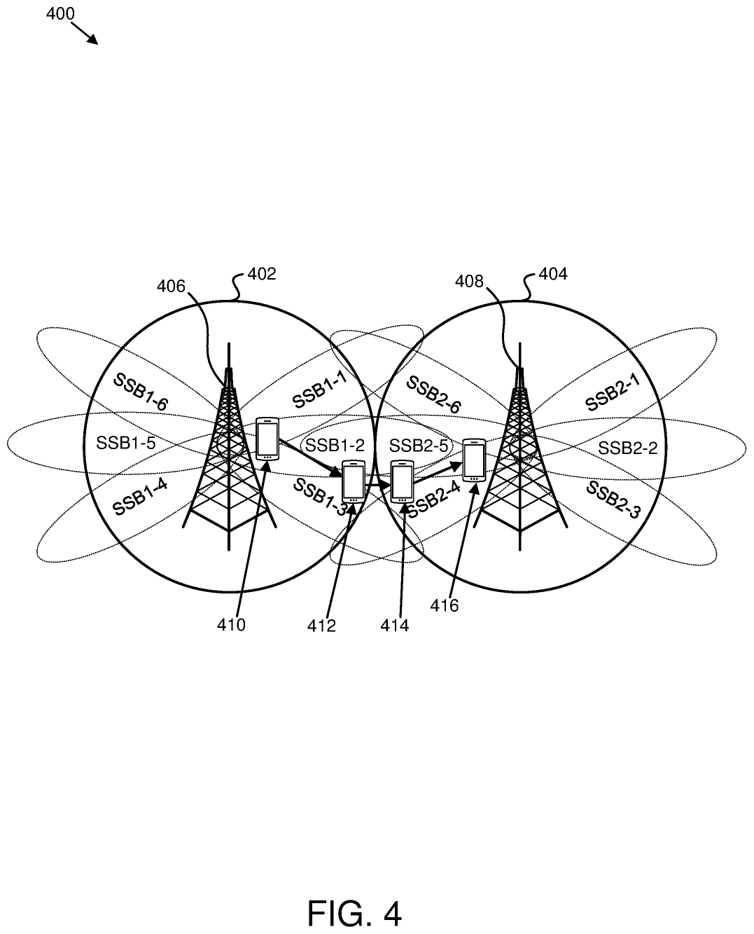

FIG. 4 is a schematic block diagram 400 illustrating one embodiment of a UE handover (e.g., L1 and/or L2 handover for the UE and the measurement of SSBs). The diagram 400 includes a first cell 402 (e.g., cell A, initial serving cell) and a second cell 404 (e.g., cell B, initial non-serving cell). Moreover, the first cell 402 includes a first network unit 406 (e.g., first gNB), and the second cell 404 includes a second network unit 408 (e.g., second gNB). FIG. 4 illustrates a UE moving from a first position 410, to a second position 412, to a third position 414, and to a fourth position 416 (e.g., moving from cell A to cell B).

When the UE is served by cell A, it is configured with all the SSBs from cell A (e.g., SSB1-1, SSB1-2, SSB1-3, SSB1-4, SSB1-5, SSB1-6) and from cell B (e.g., SSB2-1, SSB2-2, SSB2-3, SSB2-4, SSB2-5, SSB2-6), but only SSB1-1, SSB1-2, SSB1-3, SSB1-4, SSB1-5, SSB1-6, SSB2-4, SSB2-5, and SSB2-6 are activated by a MAC-CE. Because cell A is the serving cell, the UE always measures the L1-RSRP of SSB1-1, SSB1-2, SSB1-3, SSB1-4, SSB1-5, and SSB1-6 and provides measurement results to the first network unit 406 in CSI feedback. From the measured L1-RSRP of these 6 SSB signals (e.g., SSB1-1, SSB1-2, SSB1-3, SSB1-4, SSB1-5, SSB1-6), the UE finds the largest one as Rₘₐₓ^{serving cell} and compares it with a threshold Rₜₕᵣₑₛₕ^{serving cell}. FIG. 4 shows the range Rₜₕᵣₑₛₕ^{serving cell} of each cell. If Rₘₐₓ^{serving cell}≥Rₜₕᵣₑₛₕ^{serving cell}, the UE is within the circle of the first cell 402, and if Rₘₐₓ^{serving cell}<Rₜₕᵣₑₛₕ^{serving cell}, the UE is outside of the first cell 402. If the UE is at the first position 410 and the second position 412, the UE may find that Rₘₐₓ^{serving cell}≥Rₜₕᵣₑₛₕ^{serving cell}. As a result, the UE does not need to measure SSB2-4, SSB2-5, and SSB2-6. When the UE moves to the third position 414 outside the range of Rₜₕᵣₑₛₕ^{serving cell} of the first cell 402, the UE finds Rₘₐₓ^{serving cell}<Rₜₕᵣₑₛₕ^{serving cell} and this triggers the UE to start measuring the activated SSBs from the non-serving cell B (e.g., SSB2-4, SSB2-5, and SSB2-6) and reporting the measured L1-RSRP in CSI feedback sent to the first cell 402. After the UE moves to the fourth position 416, the UE may be sufficiently far away from the first cell 402 and into the second cell 404. Based on its L1-RSRP reported, the gNB in the first cell 402 may decide to conduct an L1 and/or L2 handover to the second cell 404.

In certain embodiments, measurement of SSBs from a serving cell may be important for a gNB to know which beam to use to serve a UE. In some embodiments, measurement of SSBs from a neighbor non-serving cell may be important for a gNB to know when it should handover a UE to the neighbor non-serving cell. In such embodiments, this may be more important as the UE moves towards the neighbor non-serving cell. In various embodiments, if a PDCCH is configured (e.g., in a CSI-ReportConfig), a UE may report measured L1-RSRP from both a serving cell and a non-serving cell to a gNB. L1-RSPR of both the serving cell and the non-serving cell (or cells) may be included in a same CSI report. In some embodiments, a CSI report is only designed for a serving cell and requires a UE to rank all L1-RSRP measurements in descend order and report only a first number N of results. In such embodiments, the number N may be configured by RRC (e.g., a parameter nrofReportedRS in CSI-ReportConfig). The number N may be much smaller than a number of SSBs configured (e.g., included in the CSI-ReportConfig) and activated for UE measurement, so only a subset of the measurement results may be reported to the gNB. In various embodiments, a single CSI reporting instance may include up to K L1-RSRP results from non-serving cells. In certain embodiments, a UE finds Rₘₐₓ^{non-serving cell} as a largest L1-RSRP measured from SSBs (or CSI-RSs) transmitted by non-serving cells. In such embodiments, the UE may include Rₘₐₓ^{non-serving cell} and an index of the corresponding SSB if Rₘₐₓ^{non-serving cell} is above a certain value determined by a largest L1-RSRP from the SSBs of a serving cell plus an offset value ΔR: Rₘₐₓ^{non-serving cell}≥Rₘₐₓ^{serving cell}+ΔR.

Moreover, in such embodiments, the value of ΔR may be configured by a gNB and transmitted to the UE via RRC signaling or it may be predefined (e.g., in a specification). In a first example, ΔR may have a value of −9 dBm.

In a second example, N=3, and for the UE at the third position 414, the UE's measurement of L1-RSRP from SSBs may be given in Table 1.

TABLE 1

| SSB index | L1-RSRP (dBm) |
|---|---|
| 1-1 | −125 |
| 1-2 | −120 |
| 1-3 | −127 |
| 1-4 | −133 |
| 1-5 | −150 |
| 1-6 | −138 |
| 2-4 | −130 |
| 2-5 | −128 |
| 2-6 | −133 |

In one embodiment of the second example, the UE may choose the 3 strongest SSBs (e.g., SSB1-1, SSB1-2, SSB1-3) to report to the gNB in a CSI report. In another embodiment of the second example, because a strongest SSB (e.g., SSB2-5) from a non-serving cell (e.g., Rₘₐₓ^{non-serving cell}=−128 dBm) is larger than Rₘₐₓ^{serving cell}+ΔR (e.g., −120 dBm −9 dBm=−129 dBm), the UE needs to include the measurement from SSB2-5 in the report, even if it is not among the top 3 strongest measurements of all the SSBs. Thus, the UE may report the following SSBs and their L1-RSRP values in the CSI report: {(1-2, −120 dBm), (1-1, −125 dBm), (2-5, −128 dBm)}.

In certain embodiments, a CSI report may be encoded using a differential encoding scheme. For example, one measurement value may be reported (e.g., (1-2, −120 dBm)), and the rest of the measurement values may be reported as a differential value relative to the one measurement value (e.g., (1-1, −5 dBm), (2-5, —8 dBm)).

In some embodiments, a MAC-CE may be used by a UE to report L1-RSRP measurements to a gNB. The MAC-CE may be used if no PUCCH resources are configured (e.g., in a CSI-ReportConfig), or if the next reporting instance of PUCCH is too far away in the future. It should be noted that an event-driven report using MAC-CE may reduce reporting latency and save PUCCH resources dedicated for CSI reporting. In various embodiments, a rule for including SSBs from non-serving cell in a CSI-report may be used to trigger a MAC-CE report of non-serving cell SSBs. For example, if a UE finds a SSB from a non-serving cell with an L1-RSRP above a threshold, the UE may report the SSB to a gNB in a MAC-CE message. The UE may also include L1-RSRP values of other SSBs from non-serving cells using differential encoding. In certain embodiments, to reduce hysteresis a UE may filter L1-RSRP values of each SSB with a low pass filter to get a time averaged value from a few prior measurement results. The UE may do this based on individual implementation.

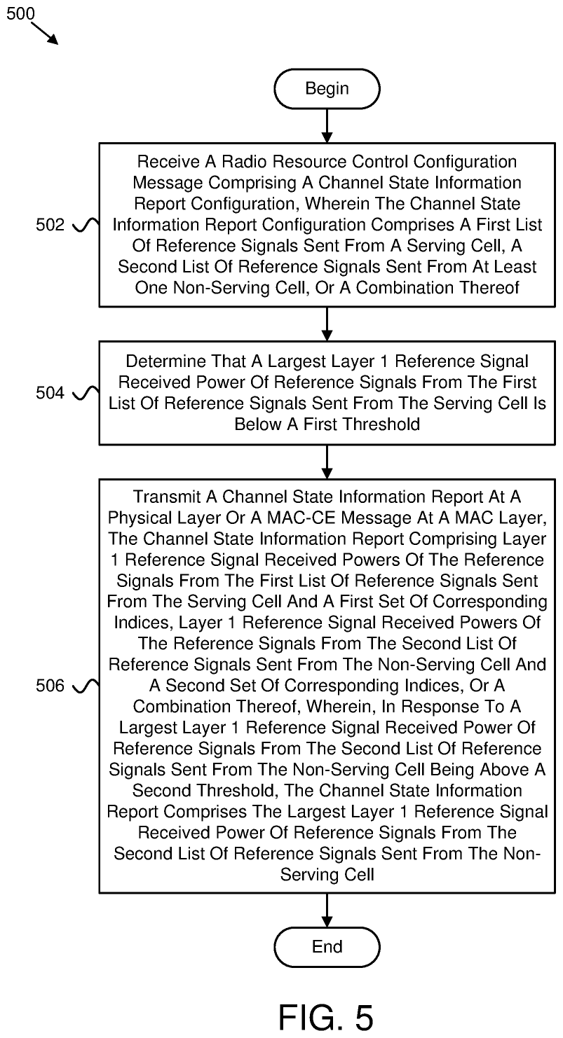

FIG. 5 is a schematic flow chart diagram illustrating one embodiment of a method 500 for layer 1 reference signal received power reporting. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

The method 500 may include receiving 502 a radio resource control configuration message including a channel state information report configuration. The channel state information report configuration includes a first list of reference signals sent from a serving cell, a second list of reference signals sent from at least one non-serving cell, or a combination thereof. In various embodiments, the method 500 includes determining 504 that a largest layer 1 reference signal received power of reference signals from the first list of reference signals sent from the serving cell is below a first threshold.

In certain embodiments, the method 500 further comprises transmitting 506 a channel state information report at a physical layer or a MAC-CE message at a MAC layer, the channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof, wherein, in response to a largest layer 1 reference signal received power of reference signals from the second list of reference signals sent from the non-serving cell being above a second threshold, the channel state information report comprises the largest layer 1 reference signal received power of reference signals from the second list of reference signals sent from the non-serving cell. In some embodiments, the second threshold equals the largest layer 1 reference signal received power of reference signals from the first list of reference signals sent from the serving cell plus an offset value.

In various embodiments, the offset value comprises a radio resource control configured parameter. In one embodiment, the offset value is predetermined. In certain embodiments, the second threshold comprises a radio resource control configured parameter.

In some embodiments, the second threshold is predetermined. In various embodiments, the method 500 further comprises, in response to a largest layer 1 reference signal received power of reference signals from the second list of reference signals sent from the non-serving cell being above a second threshold, transmitting layer 1 reference signal received powers of the reference signals from the second list of reference signals sent from the non-serving cell and a second set of corresponding indices in a medium access control control element message to a network device.

In one embodiment, in response to the layer 1 reference signal received powers of the reference signals from the second list of reference signals sent from the non-serving cell comprising a plurality of layer 1 reference signal received power values, the layer 1 reference signal received powers are transmitted using differential encoding with respect to a largest layer 1 reference signal received power of reference signals from the second list of reference signals sent from the non-serving cell. In certain embodiments, the first list of reference signals sent from the serving cell, the second list of reference signals sent from the non-serving cell, or the combination thereof comprises at least one synchronization signal block.

In some embodiments, the first list of reference signals sent from the serving cell, the second list of reference signals sent from the non-serving cell, or the combination thereof comprises at least one channel state information reference signal. In various embodiments, the first threshold comprises a radio resource control configured parameter. In one embodiment, the first threshold is predetermined.

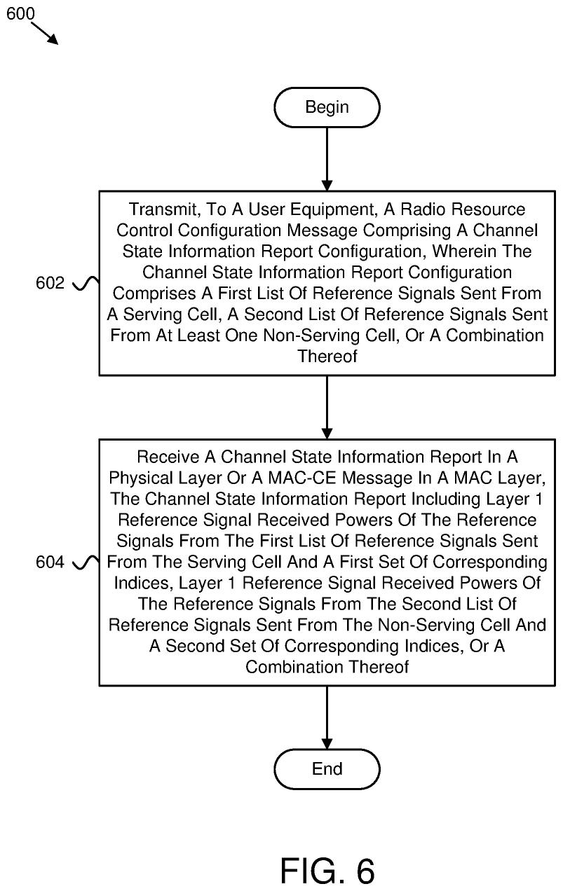

FIG. 6 is a schematic flow chart diagram illustrating another embodiment of a method 600 for layer 1 reference signal received power reporting. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

The method 600 may include transmitting 602, to a user equipment, a radio resource control configuration message includes a channel state information report configuration. The channel state information report configuration comprises a first list of reference signals sent from a serving cell, a second list of reference signals sent from at least one non-serving cell, or a combination thereof. In some embodiments, the method 600 includes receiving 604 a channel state information report in a physical layer or a MAC-CE message in a MAC layer, the channel state information report including layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof.

In certain embodiments, in response to a largest layer 1 reference signal received power of reference signals from the second list of reference signals sent from the non-serving cell being above a second threshold, the channel state information report comprises the largest layer 1 reference signal received power of reference signals from the second list of reference signals sent from the non-serving cell. In some embodiments, the second threshold equals the largest layer 1 reference signal received power of reference signals from the first list of reference signals sent from the serving cell plus an offset value.

In various embodiments, the offset value comprises a radio resource control configured parameter. In one embodiment, the offset value is predetermined. In certain embodiments, the second threshold comprises a radio resource control configured parameter.

In some embodiments, the second threshold is predetermined. In various embodiments, the method 600 further comprises, in response to a largest layer 1 reference signal received power of reference signals from the second list of reference signals sent from the non-serving cell being above a second threshold, receiving layer 1 reference signal received powers of the reference signals from the second list of reference signals sent from the non-serving cell and a second set of corresponding indices in a medium access control control element message.

In one embodiment, in response to the layer 1 reference signal received powers of the reference signals from the second list of reference signals sent from the non-serving cell comprising a plurality of layer 1 reference signal received power values, the layer 1 reference signal received powers are received using differential encoding with respect to a largest layer 1 reference signal received power of reference signals from the second list of reference signals sent from the non-serving cell. In certain embodiments, the first list of reference signals sent from the serving cell, the second list of reference signals sent from the non-serving cell, or the combination thereof comprises at least one synchronization signal block.

In some embodiments, the first list of reference signals sent from the serving cell, the second list of reference signals sent from the non-serving cell, or the combination thereof comprises at least one channel state information reference signal.

In one embodiment, a method of a user equipment comprises: receiving a radio resource control configuration message comprising a channel state information report configuration, wherein the channel state information report configuration comprises a first list of reference signals sent from a serving cell, a second list of reference signals sent from at least one non-serving cell, or a combination thereof; and determining that a largest layer 1 reference signal received power of reference signals from the first list of reference signals sent from the serving cell is below a first threshold.

In certain embodiments, the method further comprises transmitting a channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof, wherein, in response to a largest layer 1 reference signal received power of reference signals from the second list of reference signals sent from the non-serving cell being above a second threshold, the channel state information report comprises the largest layer 1 reference signal received power of reference signals from the second list of reference signals sent from the non-serving cell.

In some embodiments, the second threshold equals the largest layer 1 reference signal received power of reference signals from the first list of reference signals sent from the serving cell plus an offset value.

In various embodiments, the offset value comprises a radio resource control configured parameter.

In one embodiment, the offset value is predetermined.

In certain embodiments, the second threshold comprises a radio resource control configured parameter.

In some embodiments, the second threshold is predetermined.

In various embodiments, the method further comprises, in response to a largest layer 1 reference signal received power of reference signals from the second list of reference signals sent from the non-serving cell being above a second threshold, transmitting layer 1 reference signal received powers of the reference signals from the second list of reference signals sent from the non-serving cell and a second set of corresponding indices in a medium access control control element message to a network device.

In one embodiment, in response to the layer 1 reference signal received powers of the reference signals from the second list of reference signals sent from the non-serving cell comprising a plurality of layer 1 reference signal received power values, the layer 1 reference signal received powers are transmitted using differential encoding with respect to a largest layer 1 reference signal received power of reference signals from the second list of reference signals sent from the non-serving cell.

In certain embodiments, the first list of reference signals sent from the serving cell, the second list of reference signals sent from the non-serving cell, or the combination thereof comprises at least one synchronization signal block.

In some embodiments, the first list of reference signals sent from the serving cell, the second list of reference signals sent from the non-serving cell, or the combination thereof comprises at least one channel state information reference signal.

In various embodiments, the first threshold comprises a radio resource control configured parameter.

In one embodiment, the first threshold is predetermined.

In one embodiment, an apparatus comprises a user equipment. In such embodiments, the apparatus further comprises: a receiver that: receives a radio resource control configuration message comprising a channel state information report configuration, wherein the channel state information report configuration comprises a first list of reference signals sent from a serving cell, a second list of reference signals sent from at least one non-serving cell, or a combination thereof; and a processor that determines that a largest layer 1 reference signal received power of reference signals from the first list of reference signals sent from the serving cell being below a first threshold.

In certain embodiments, the apparatus further comprises a transmitter that transmits a channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof, wherein, in response to a largest layer 1 reference signal received power of reference signals from the second list of reference signals sent from the non-serving cell being above a second threshold, the channel state information report comprises the largest layer 1 reference signal received power of reference signals from the second list of reference signals sent from the non-serving cell.

In some embodiments, the second threshold equals the largest layer 1 reference signal received power of reference signals from the first list of reference signals sent from the serving cell plus an offset value.

In various embodiments, the offset value comprises a radio resource control configured parameter.

In one embodiment, the offset value is predetermined.

In certain embodiments, the second threshold comprises a radio resource control configured parameter.

In some embodiments, the second threshold is predetermined.

In various embodiments, the apparatus further comprises a transmitter that, in response to a largest layer 1 reference signal received power of reference signals from the second list of reference signals sent from the non-serving cell being above a second threshold, transmits layer 1 reference signal received powers of the reference signals from the second list of reference signals sent from the non-serving cell and a second set of corresponding indices in a medium access control control element message to a network device.

In one embodiment, in response to the layer 1 reference signal received powers of the reference signals from the second list of reference signals sent from the non-serving cell comprising a plurality of layer 1 reference signal received power values, the layer 1 reference signal received powers are transmitted using differential encoding with respect to a largest layer 1 reference signal received power of reference signals from the second list of reference signals sent from the non-serving cell.

In certain embodiments, the first list of reference signals sent from the serving cell, the second list of reference signals sent from the non-serving cell, or the combination thereof comprises at least one synchronization signal block.

In some embodiments, the first list of reference signals sent from the serving cell, the second list of reference signals sent from the non-serving cell, or the combination thereof comprises at least one channel state information reference signal.

In various embodiments, the first threshold comprises a radio resource control configured parameter.

In one embodiment, the first threshold is predetermined.

In one embodiment, a method of a network device comprises: transmitting, to a user equipment, a radio resource control configuration message comprising a channel state information report configuration, wherein the channel state information report configuration comprises a first list of reference signals sent from a serving cell, a second list of reference signals sent from at least one non-serving cell, or a combination thereof; and receiving a channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof.

In certain embodiments, in response to a largest layer 1 reference signal received power of reference signals from the second list of reference signals sent from the non-serving cell being above a second threshold, the channel state information report comprises the largest layer 1 reference signal received power of reference signals from the second list of reference signals sent from the non-serving cell.

In some embodiments, the second threshold equals the largest layer 1 reference signal received power of reference signals from the first list of reference signals sent from the serving cell plus an offset value.

In various embodiments, the offset value comprises a radio resource control configured parameter.

In one embodiment, the offset value is predetermined.

In certain embodiments, the second threshold comprises a radio resource control configured parameter.

In some embodiments, the second threshold is predetermined.

In various embodiments, the method further comprises, in response to a largest layer 1 reference signal received power of reference signals from the second list of reference signals sent from the non-serving cell being above a second threshold, receiving layer 1 reference signal received powers of the reference signals from the second list of reference signals sent from the non-serving cell and a second set of corresponding indices in a medium access control control element message.

In one embodiment, in response to the layer 1 reference signal received powers of the reference signals from the second list of reference signals sent from the non-serving cell comprising a plurality of layer 1 reference signal received power values, the layer 1 reference signal received powers are received using differential encoding with respect to a largest layer 1 reference signal received power of reference signals from the second list of reference signals sent from the non-serving cell.

In certain embodiments, the first list of reference signals sent from the serving cell, the second list of reference signals sent from the non-serving cell, or the combination thereof comprises at least one synchronization signal block.

In some embodiments, the first list of reference signals sent from the serving cell, the second list of reference signals sent from the non-serving cell, or the combination thereof comprises at least one channel state information reference signal.

In one embodiment, an apparatus comprises a network device. In such embodiments, the apparatus further comprises: a transmitter that transmits, to a user equipment, a radio resource control configuration message comprising a channel state information report configuration, wherein the channel state information report configuration comprises a first list of reference signals sent from a serving cell, a second list of reference signals sent from at least one non-serving cell, or a combination thereof; and a receiver that receives a channel state information report comprising layer 1 reference signal received powers of the reference signals from the first list of reference signals sent from the serving cell and a first set of corresponding indices, layer 1 reference signal received powers of the reference signals from the second list of reference signals sent from the non-serving cell and a second set of corresponding indices, or a combination thereof.

In certain embodiments, in response to a largest layer 1 reference signal received power of reference signals from the second list of reference signals sent from the non-serving cell being above a second threshold, the channel state information report comprises the largest layer 1 reference signal received power of reference signals from the second list of reference signals sent from the non-serving cell.

In some embodiments, the second threshold equals the largest layer 1 reference signal received power of reference signals from the first list of reference signals sent from the serving cell plus an offset value.

In various embodiments, the offset value comprises a radio resource control configured parameter.

In one embodiment, the offset value is predetermined.

In certain embodiments, the second threshold comprises a radio resource control configured parameter.

In some embodiments, the second threshold is predetermined.

In various embodiments, the receiver, in response to a largest layer 1 reference signal received power of reference signals from the second list of reference signals sent from the non-serving cell being above a second threshold, receives layer 1 reference signal received powers of the reference signals from the second list of reference signals sent from the non-serving cell and a second set of corresponding indices in a medium access control control element message.

In one embodiment, in response to the layer 1 reference signal received powers of the reference signals from the second list of reference signals sent from the non-serving cell comprising a plurality of layer 1 reference signal received power values, the layer 1 reference signal received powers are received using differential encoding with respect to a largest layer 1 reference signal received power of reference signals from the second list of reference signals sent from the non-serving cell.

In certain embodiments, the first list of reference signals sent from the serving cell, the second list of reference signals sent from the non-serving cell, or the combination thereof comprises at least one synchronization signal block.

In some embodiments, the first list of reference signals sent from the serving cell, the second list of reference signals sent from the non-serving cell, or the combination thereof comprises at least one channel state information reference signal.

Embodiments may be practiced in other specific forms. One or more of the embodiments described herein may be combined to form another embodiment. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment (UE), the method comprising:
receiving a radio resource control (RRC) configuration message comprising a channel state information (CSI) report configuration, wherein the CSI report configuration comprises a first list of reference signals (RSs) sent from a serving cell, a second list of RSs sent from at least one non-serving cell, or a combination thereof; and
determining that a largest layer 1 (L1) RS received power of RSs from the first list of RSs sent from the serving cell is below a first threshold.

2. The method of claim 1, further comprising transmitting a CSI report comprising L1 RS received powers of the RSs from the first list of RSs sent from the serving cell and a first set of corresponding indices, L1 RS received powers of the RSs from the second list of RSs sent from the non-serving cell and a second set of corresponding indices, or a combination thereof, wherein, in response to a largest L1 RS received power of RSs from the second list of RSs sent from the non-serving cell being above a second threshold, the CSI report comprises the largest L1 RS received power of RSs from the second list of RSs sent from the non-serving cell.

3. The method of claim 2, wherein the second threshold equals the largest L1 RS received power of RSs from the first list of RSs sent from the serving cell plus an offset value.

4. The method of claim 3, wherein the offset value comprises a RRC configured parameter.

5. The method of claim 3, wherein the offset value is predetermined.

6. The method of claim 2, wherein the second threshold comprises a RRC configured parameter.

7. The method of claim 2, wherein the second threshold is predetermined.

8. The method of claim 1, further comprising, in response to a largest L1 RS received power of RSs from the second list of RSs sent from the non-serving cell being above a second threshold, transmitting L1 RS received powers of the RSs from the second list of RSs sent from the non-serving cell and a second set of corresponding indices in a medium access control control element (MAC-CE) message to a network device.

9. The method of claim 8, wherein, in response to the L1 RS received powers of the RSs from the second list of RSs sent from the non-serving cell comprising a plurality of L1 RS received power values, the L1 RS received powers are transmitted using differential encoding with respect to a largest L1 RS received power of RSs from the second list of RSs sent from the non-serving cell.

10. The method of claim 1, wherein the first list of RSs sent from the serving cell, the second list of RSs sent from the non-serving cell, or the combination thereof comprises at least one synchronization signal block (SSB).

11. The method of claim 1, wherein the first list of RSs sent from the serving cell, the second list of RSs sent from the non-serving cell, or the combination thereof comprises at least one CSI reference signal.

12. The method of claim 1, wherein the first threshold comprises a RRC configured parameter.

13. The method of claim 1, wherein the first threshold is predetermined.

14. A user equipment (UE), comprising:
at least one memory; and
at least one processor coupled with the at least one memory and configured to cause the UE to:
receive a radio resource control (RRC) configuration message comprising a channel state information (CSI) report configuration, wherein the CSI report configuration comprises a first list of reference signals (RSs) sent from a serving cell, a second list of RSs sent from at least one non-serving cell, or a combination thereof; and
determine that a largest layer 1 (L1) RS received power of RSs from the first list of RSs sent from the serving cell being below a first threshold.

15. A base station, comprising:
at least one memory; and
at least one processor coupled with the at least one memory and configured to cause the base station to:
transmit, to a user equipment (UE), a radio resource control (RRC) configuration message comprising a channel state information (CSI) report configuration, wherein the CSI report configuration comprises a first list of reference signals (RSs) sent from a serving cell, a second list of RSs sent from at least one non-serving cell, or a combination thereof; and
receive a CSI report comprising layer 1 (L1) RS received powers of the RSs from the first list of RSs sent from the serving cell and a first set of corresponding indices, L1 RS received powers of the RSs from the second list of RSs sent from the non-serving cell and a second set of corresponding indices, or a combination thereof.

16. A processor for wireless communication, comprising:
at least one controller coupled with at least one memory and configured to cause the processor to:
receive a radio resource control (RRC) configuration message comprising a channel state information (CSI) report configuration, wherein the CSI report configuration comprises a first list of reference signals (RSs) sent from a serving cell, a second list of RSs sent from at least one non-serving cell, or a combination thereof; and
determine that a largest layer 1 (L1) RS received power of RSs from the first list of RSs sent from the serving cell being below a first threshold.

17. The processor of claim 16, wherein the at least one controller is configured to cause the processor to transmit a CSI report comprising L1 RS received powers of the RSs from the first list of RSs sent from the serving cell and a first set of corresponding indices, L1 RS received powers of the RSs from the second list of RSs sent from the non-serving cell and a second set of corresponding indices, or a combination thereof, wherein, in response to a largest L1 RS received power of RSs from the second list of RSs sent from the non-serving cell being above a second threshold, the CSI report comprises the largest L1 RS received power of RSs from the second list of RSs sent from the non-serving cell.

18. The processor of claim 17, wherein the second threshold equals the largest L1 RS received power of RSs from the first list of RSs sent from the serving cell plus an offset value.

19. The processor of claim 18, wherein the offset value comprises a RRC configured parameter.

20. The processor of claim 18, wherein the offset value is predetermined.
